(19) United States
(12) Patent Application Publication
(10) Pub. No.: US 2008/0129463 A1
(43) Pub. Date: Jun. 5, 2008

(54) RFID tag including ROM, method of impeding an RFID tag from being killed, and method of manufacturing an RFID tag

(75) Inventor: John R. Tuttle, Boulder, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Micron Technology, Inc.

(21) Appl. No.: 11/607,217

(22) Filed: Dec. 1, 2006

(51) Int. Cl. H04Q 5/22; G08B 13/14

(52) U.S. Cl. 340/10.5; 340/572.1

(57) ABSTRACT

An RFID tag includes read-only memory obtaining a kill password that cannot be changed, wherein it is not possible for a reader to kill a RFID tag by sending a kill command. A method of manufacturing an RFID tag and a method of impeding an RFID tag from being killed by a kill command are also disclosed.

### TECHNICAL FIELD

The technical field comprises radio frequency identification devices, systems, and methods.

### BACKGROUND

Radio frequency identification devices (RFIDs) are known in the art. Such devices are typically used for inventory tracking. As large numbers of objects are moved in inventory, product manufacturing, and merchandising operations, there is a continuous challenge to accurately monitor the location and flow of objects. Additionally, there is a continuing goal to determine the location of objects in an inexpensive and streamlined manner. One way to track objects is by affixing RFID tags to objects or groups of objects, and interrogating the RFID tags with an interrogator or reader to determine which objects are present in any particular location. RFID tags may be provided with unique identification numbers or codes in order to enable a reader to distinguish between multiple different tags.

Some RFID tags use the electromagnetic field generated by a nearby interrogator for power. Conventionally, such devices are passive (have no power supply), which results in a small and portable package.

Another type of RFID tag is an active RFID tag, which includes its own source of power, such as a battery.

RFID standards bodies have ratified standards that are general in scope. A goal of such bodies is to accommodate a large variety of potential applications for the technology. In some potential applications, all of the functionality required by such standards is not necessary or desirable. Some designers would prefer if certain choices were not available.

An example of an RFID standard setting body is EPCglobal. EPCglobal is developing standards for electronic product codes to support the use of RFID technology. One of their standards, called Class 1, Generation 2 (also known as “Gen 2”) applies to passive RFID systems, and is described on their websites at www.epcglobalus.org or www.epcglobalinc.org. These standards evolve over time, and for a particular standard, such as Gen 2, there are minor variations between versions.

The EPCglobal Class 1, Generation 2 standard mandates that tag memory shall be logically separated into banks including “reserved” memory that contains kill and access passwords. The banks are also to include “EPC memory” including a code that identifies the object to which the tag is or will be attached, “TID” memory including a tag class identifier and sufficient identifying information for a reader to uniquely identify the custom commands or optional features that a tag supports, and “user memory” that allows user-specific data storage. The logical addressing of all memory banks is to begin at zero. Reader commands for accessing memory are to have a parameter that selects a bank, and an address parameter.

The EPCglobal Class 1, Generation 2 standard mandates that a kill password be stored in the reserved memory bank at addresses 00 to IF (hexadecimal) with the most significant bit first. The default value of this kill password is supposed to be zero. A reader can use a tag's kill password once to kill a tag and render it silent thereafter, by sending a kill command to a tag containing a password matching the kill password stored in the tag. A tag is not supposed to execute a kill operation if its kill password is zero. The present version of the Class 1, Generation 2 standard is version 1.0.9.

A disadvantage of allowing tags to be killed using a kill command is that unauthorized readers may maliciously kill tags. For example, some people may have irrational privacy fears or a dislike of certain retailers and may endeavor to kill tags without authorization to do so.

Further, there is a price to pay when developing products to meet these mandatory generalized specifications. Unnecessary complexity, poor performance, and expensive hardware requirements may have to be tolerated in order to comply with the specifications and provide capabilities that may not be needed, or even desired, for particular applications.

### BRIEF DESCRIPTION OF THE DRAWINGS

FIG. 1 is a block diagram of a system according to various embodiments of the present disclosure.

FIG. 2 is a block diagram of an RFID tag included in the system of FIG. 1, in one embodiment. Other embodiments are also contemplated.

FIG. 3 is a logical memory map illustrating locations of items in memory of the RFID tag of FIG. 2, in one embodiment. Other embodiments are also contemplated.

### DETAILED DESCRIPTION OF THE ILLUSTRATED EMBODIMENTS

Various embodiments of the invention provide an RFID tag comprising read-only memory containing a kill password that cannot be changed, wherein it is rendered impossible for a reader to kill a tag by sending a kill command.

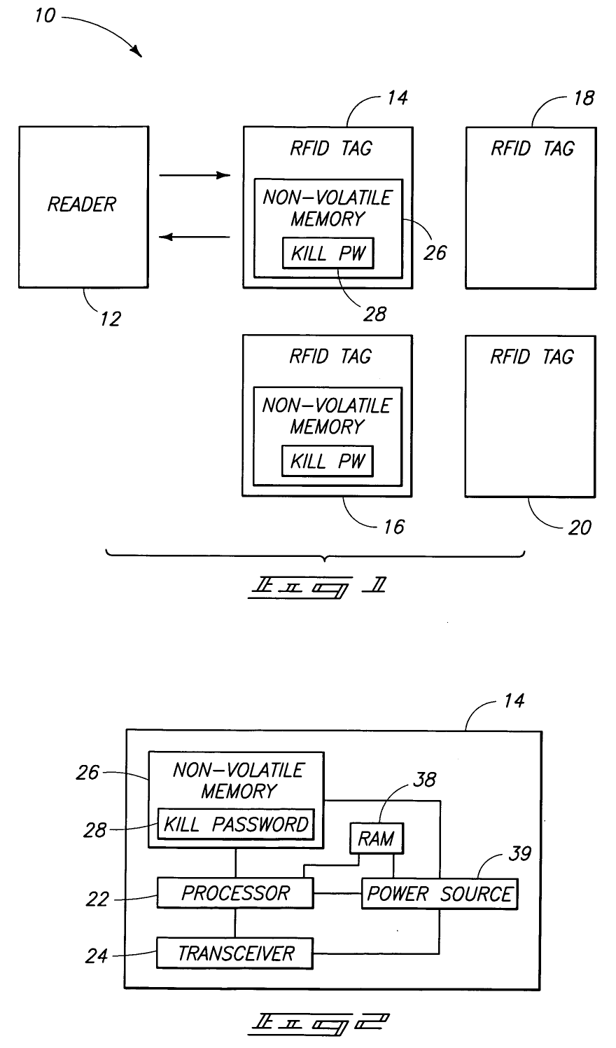

FIG. 1 shows a system 10 in accordance with various embodiments of the invention. The system 10 includes an RFID reader 12, and a plurality of RFID tags 14, 16, 18, and 20. Although only RFID four tags are shown, for simplicity, the system 10 can include any number of tags.

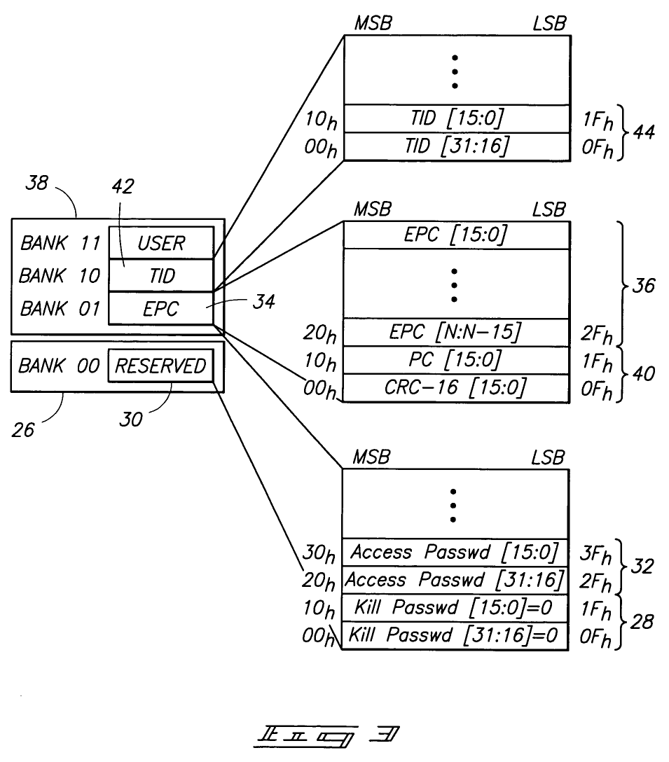

At least one of the RFID tags 14 includes (see FIG. 2) a processor 22, and a transceiver 24 coupled to the processor 22. The RFID tag 14 responds to commands issued by the reader 12 and received by the transceiver 24. The processor 22 processes received commands and the processor causes the transceiver 24 to transmit a reply. In some embodiments, the reply is backscattered.

The RFID tag 14 further includes non-volatile memory 26 coupled to the processor 22. In some embodiments, the memory 26 comprises ROM. More particularly, in some embodiments, the memory 26 comprises contact ROM. In some embodiments, the memory 26 is mask programmable. In some embodiments, the memory 26 comprises NRAM (nanotube non-volatile RAM). In other embodiments, any other desired type of non-volatile memory 26 is employed.

Power is supplied by a power source 39 which may be a magnetic coil, battery, or other type of power source.

In the illustrated embodiments, memory 26 contains a kill password 28 that cannot be changed. More particularly, in some embodiments, the RFID tag 14 includes (see FIG. 3) a reserved memory block or bank 30 that contains the kill password 28 with an unchangeable (unalterable) value set to zero (e.g., 0000H). By using a read only-memory, or non-volatile memory, to store the kill password, it is not possible for the reader 12 or another reader to kill the tag by sending a kill command. Thus, in some embodiments, the read-only memory contains a kill password that cannot be changed, wherein it is not possible for a reader to kill a tag by sending a kill command. Malicious attempts to kill the RFID tag 14 are impeded.

In some embodiments, the processor 22 will not attempt to execute a kill command received by an RFID tag 14. In some embodiments, the processor 22 does not allow a check for a valid kill password to be made. In some embodiments, the processor 22 causes a reply to be sent to a reader that attempts to kill an RFID tag, with a message or code indicating that the tag cannot be killed.

In some embodiments, the reserved memory block 30 further stores an access password 32. In the illustrated embodiments, the access password 32 has a default (unprogrammed) value of zero. Tags with nonzero access passwords require a reader to issue the access password before transitioning to a secured state.

In some embodiments, the RFID tag 14 comprises an EPC memory block or bank 34 containing at least an electronic product code 36 for use in identifying an object to which the tag is or will be affixed. In the illustrated embodiment, the EPC memory block 34 further includes memory 40 for a cyclic redundancy check and CRC precursor. In some embodiments, the EPC memory block 34 is included in conventional RAM 38 (see FIG. 2). In other embodiments, the EPC memory block 34 is included in the read-only or non-volatile memory 26.

In some embodiments, the RFID tag 14 comprises a TID memory block or bank 42 including TID information 44 that the reader 12 (or another reader) uses to identify custom commands that the RFID tag 14 supports.

In some embodiments, some tags, such as tags 14 and 16, include the non-volatile memory storing the kill password. Other RFID tags, such as RFID tags 18 and 20, are RFID tags that comply with the EPCglobal Class 1, Generation 2 standard.

In some embodiments, the tags 14 and 16 comply with the EPCglobal Class 1, Generation 2 standard except to the extent that the non-volatile or read-only memory 26 does not comply with the standard.

Applications for such a RFID tag 14 include, for example, high tag volume environments such as airport luggage tagging and product manufacturing and distribution.

Use of the RFID tag 14 having the memory 26 with the unalterable kill password may cause error messages at the reader 12. Such error messages will be predictable and reproducible. In some embodiments, the readers 12 are modified to include error handling to accommodate such tags.

In compliance with the statute, the subject matter disclosed herein has been described in language more or less specific as to structural and methodical features. It is to be understood, however, that the claims are not limited to the specific features shown and described, since the means herein disclosed comprise example embodiments. The claims are thus to be afforded full scope as literally worded, and to be appropriately interpreted in accordance with the doctrine of equivalents.

I/we claim:

1. A radio frequency identification device (RFID) tag comprising:
a processor;
a transceiver coupled to the processor, the RFID tag being configured to respond to commands issued by a reader and received by the transceiver; and
read-only memory coupled to the processor, the read-only memory containing a kill password that cannot be changed, the kill password being set at a value selected such that it is not possible for a reader to kill a RFID tag by sending a kill command.

2. An RFID tag in accordance with claim 1 wherein the read-only memory is a contact ROM.

3. An RFID tag in accordance with claim 1 wherein the read-only memory is mask programmable.

4. An RFID tag in accordance with claim 1 wherein the read-only memory has a kill password of zero.

5. An RFID tag in accordance with claim 1 wherein the read-only memory has an unalterable kill password of 0000H.

6. An RFID tag in accordance with claim 1 and comprising memory including TID information for the reader to use to be able to identify custom commands that the tag supports.

7. An RFID tag in accordance with claim 1 and comprising a reserved memory block that contains the kill password.

8. An RFID tag in accordance with claim 1 and comprising a reserved memory block containing the kill password and also containing an access password, and wherein the tag includes memory containing an EPC memory block, and memory containing a TID memory block.

9. An RFID tag comprising:
read-only memory containing a kill password that cannot be changed, wherein it is not possible for a reader to kill a RFID tag by sending a kill command.

10. An RFID tag in accordance with claim 9 wherein the read-only memory has a kill password of zero.

11. An RFID tag in accordance with claim 9 and comprising memory including TID information for the reader to use to be able to identify custom commands that the tag supports.

12. An RFID tag in accordance with claim 9 and comprising a reserved memory block that contains the kill password.

13. An RFID tag in accordance with claim 9 and comprising a reserved memory block containing the kill password and also containing an access password, and wherein the tag includes memory containing an EPC memory block, and memory containing a TID memory block.

14. A method of manufacturing an RFID tag, the method comprising:
coupling a transceiver to a processor, and configuring the tag to respond to commands issued by a reader and received by the transceiver;
coupling read-only memory to the processor, and
storing in the read-only memory a kill password that cannot be changed, the kill password being set at a value selected to render it impossible for a reader to kill the RFID tag by sending a kill command.

15. A method of manufacturing an RFID tag in accordance with claim 14 and comprising using contact ROM for the read-only memory.

16. A method of manufacturing an RFID tag in accordance with claim 14 and comprising mask programming the read-only memory.

17. A method of manufacturing an RFID tag in accordance with claim 14 and comprising storing a kill password of zero in the read-only memory.

18. A method of manufacturing an RFID tag in accordance with claim 14 and comprising storing an unalterable kill password of 0000H in the read-only memory.

19. A method of impeding an RFID tag from being killed by a kill command, the method comprising:
using a non-volatile memory to store a kill password; and
setting the stored kill password at zero.

20. A method of impeding an RFID tag from being killed by a kill command in accordance with claim 19, the method comprising manufacturing the RFID tag to comply with the EPCglobal Class 1, Generation 2 standard except for the use of use of non-volatile memory.

21. A system comprising:
an RFID reader; and
a plurality of RFID tags, at least one of the RFID tags including:
a processor;
a transceiver coupled to the processor, the RFID tag being configured to respond to commands issued by the reader and received by the transceiver; and
read-only memory coupled to the processor, the read-only memory containing a kill password that cannot be changed, the kill password being a value selected to render it impossible for a reader to kill the RFID tag by sending a kill command, the read-only memory further including an electronic product code.

22. A system in accordance with claim 21 wherein the RFID tag that has the read-only memory comprises memory including TID information for the reader to be able to identify custom commands that the RFID tag having the read-only memory supports.

23. A system in accordance with claim 21 wherein the RFID tag that has the read-only memory includes a reserved memory block that contains the kill password.

24. A system in accordance with claim 21 wherein the read-only memory includes a reserved memory block containing the kill password and also containing an access password, and wherein the RFID tag includes memory containing an EPC memory block, and a TID memory block.

25. A system in accordance with claim 21 and further comprising RFID tags that comply with the EPCglobal Class 1, Generation 2 standard.

26. A system in accordance with claim 21 wherein the RFID tag that has the read-only memory complies with the EPCglobal Class 1, Generation 2 standard except to the extent that read-only memory does not comply.

27. A method comprising:
providing an RFID tag, the providing including coupling a transceiver to a processor, and configuring the RFID tag to respond to commands issued by a reader and received by the transceiver; and
coupling read-only memory to the processor;
storing in the read-only memory a kill password that cannot be changed, wherein it is not possible for a reader to kill the RFID tag by sending a kill command; and
storing in the read-only memory an electronic product code.

28. A method in accordance with claim 27 and further comprising storing in the RFID tag TID information for the reader to use to be able to identify custom commands that the RFID tag having the read-only memory supports.

29. A method in accordance with claim 27 wherein the read-only memory includes a reserved memory block and wherein the storing the kill password comprises storing the kill password in the reserved memory block.

30. A method in accordance with claim 27 wherein the read-only memory includes a reserved memory block, wherein the storing the kill password comprises storing the kill password in the reserved memory block, and wherein the RFID tag further includes an EPC memory block, and a TID memory block.

31. A method in accordance with claim 27 wherein the RFID tag is manufactured to comply with the EPCglobal Class 1, Generation 2 standard except to the extent that the read-only memory does not comply.

32. An RFID tag comprising:
processor means;
means for receiving and responding to commands from a reader; and
means for resisting attempts to kill the RFID tag.

33. An RFID tag in accordance with claim 32 and comprising non-volatile memory storing a kill password that cannot be changed, the kill password having a value selected such that it is not possible for a reader to kill the RFID tag by sending a kill command.

34. An RFID tag in accordance with claim 33 wherein the read-only memory is a contact ROM.

35. An RFID tag in accordance with claim 33 wherein the read-only memory is mask programmable.

36. An RFID tag in accordance with claim 33 wherein the read-only memory has a kill password of zero.

37. An RFID tag in accordance with claim 33 wherein the read-only memory has an unalterable kill password of 0000H.

38. An RFID tag comprising:
means for storing a kill password that cannot be changed, and setting the password at a value rendering it impossible for a reader to kill a RFID tag by sending a kill command.

39. An RFID tag in accordance with claim 38 wherein the storing means has a kill password of zero.

40. A system comprising:
an RFID reader; and
a plurality of RFID tags, at least one of the RFID tags including:
means for processing commands received from the reader;
means for receiving commands from the reader and for transmitting replies to the reader; and
means for storing a kill password that cannot be changed, wherein it is not possible for the reader to kill the RFID tag by sending a kill command, the storing means further including an electronic product code.

41. A system in accordance with claim 40 wherein at least one of the RFID tags comprises means for storing TID information for the reader to use to be able to identify custom commands that the RFID tag having the read-only memory supports.

42. A system in accordance with claim 40 wherein the RFID tag that has the storing means includes a reserved memory block that contains the kill password.

43. A system in accordance with claim 40 wherein the storing means includes a reserved memory block containing the kill password, and wherein the RFID tag that has the storing means includes means for providing an EPC memory block, and means for providing a TID memory block.

44. A system in accordance with claim 40 and further comprising RFID tags that comply with the EPCglobal Class 1, Generation 2 standard.

45. A system in accordance with claim 40 wherein the RFID tag that has the storing means complies with the EPCglobal Class 1, Generation 2 standard except to the extent that the storing means does not comply.

46. A radio frequency identification device (RFID) tag comprising:
a processor;
a transceiver coupled to the processor, the RFID tag being configured to respond to commands issued by a reader and received by the transceiver; and
memory configured to store electronic product code data, and wherein the processor is configured to ignore a kill command received from a reader.

47. An RFID tag in accordance with claim 46 and comprising memory including TID information for the reader to use to be able to identify custom commands that the tag supports.

48. An RFID tag in accordance with claim 46 and comprising a reserved memory block that contains a kill password.

49. An RFID tag in accordance with claim 48 and comprising a reserved memory block containing the kill password and also containing an access password, and wherein the tag includes memory containing a TID memory block.

50. A radio frequency identification device (RFID) tag comprising:
a processor;
a transceiver coupled to the processor, the RFID tag being configured to respond to commands issued by a reader and received by the transceiver; and
memory configured to store data identifying the object to which the RFID tag is intended to be affixed, and wherein the RFID tag is configured to selectively return a message to a reader indicating that the RFID tag cannot be killed.

51. A radio frequency identification device (RFID) in accordance with claim 50 wherein the RFID tag is configured to return the message in response to receiving a kill command from a reader.

52. A radio frequency identification device (RFID) tag comprising:
a processor;
a transceiver coupled to the processor, the RFID tag being configured to respond to commands issued by a reader and received by the transceiver; and
memory configured to store data identifying the object to which the RFID tag is intended to be affixed, and wherein the RFID tag is configured to not perform a kill function responsive to receiving a command from a reader to kill the tag.
